(19) United States
(12) Patent Application Publication
(10) Pub. No.: US 2007/0271255 A1
(43) Pub. Date: Nov. 22, 2007

(54) Reverse search-engine

(76) Inventor: Nicky Pappo, Haifa (IL)

Correspondence Address: Martin D. Moynihan;PRTSI, Inc., P.O. Box 16446, Arlington, VA, 22215, US

(21) Appl. No.: 11/494,647

(22) Filed: Jul. 28, 2006

Related U.S. Application Data
(60) Provisional application No. 60/747,418, filed on May 17, 2006.

(51) Int. Cl. G06F 17/30

(52) U.S. Cl. 707/5

(57) ABSTRACT

A device for managing document search-pattern records. The device comprises an associative memory for recording the usage in keywords of search queries such that each keyword is associated with at least one document responsive to the search query. The device is configured for managing access to the associative memory. The device is configured, in one embodiment of the present invention, to retrieve related keywords of the recorded keywords in response to an address of a certain document which is associated with the related keywords.

### RELATED APPLICATION

This Application claims the benefit of U.S. Provisional Patent Application No. 60/747,418, filed on May 17, 2006, the contents of which are hereby incorporated by reference.

### FIELD AND BACKGROUND OF THE INVENTION

The present invention relates in general to the use of search-engines in communication networks and, more particularly but not exclusively, to a device, system and method which allow network users to refine their searches based upon document search patterns or keyword usage of other network users.

Database searching, such as Internet searching, is now the subject of much activity as well as research. Search-engines for both general and specific purposes abound. For example, search-engines from such Websites as Google.com, Yahoo.com, Excite.com, Lycos.com, and Northernlight.com all attempt to build an index of the World Wide Web by accumulating Website information in a centralized database on a centralized computer system. Thus, any of these systems involves literally indexing tens of billions of pages of information in order to allow a search for information to be accomplished. Thus, when a user desires to find specific information, the selected search-engine must search its centralized index database. Searching through the centralized index database involves a user building a query and submitting it through the search-engine. The query usually comprises one or more keywords that the user considers related to the searched information.

The centralized index database typically returns the search results in response to a user's search request in a ranked list of document representations that include titles, abstracts and hyperlinks, ordered by their estimated relevance to the query included in the search request. Users can sift through the ranked list and select documents that are actually relevant or interesting.

As described above, the search is based upon a search query that comprises a number of keywords. Since the keywords are chosen according to user assessment, they may be ambiguous and not directly related to the requested information. Thus, the ranked list may comprise links to irrelevant Web pages and documents. It should be noted that, for very large document collections, such as the Web page collection of the Internet or document collection of large entities such as libraries, the returned search result list is typically large. Accordingly, it would be very difficult for the user to find information from a list of hundreds or thousands of candidate documents that include a substantial amount of irrelevant results.

Several methods and systems were developed in order to improve the relevance of the result list's elements to the user. For example, U.S. Patent Application No. 2006/0136378 published on Jun. 22, 2006, discloses a client-side program, which is employed to observe the navigation of consumers to various Websites in order to improve search results. This application discloses a method in which addresses of Web pages viewed by consumers are used to fetch the Web pages. A fetched Web page is parsed for one or more keywords. The relevance of the Web page to a keyword is ranked according to consumer preferences, which is also related to consumer interaction with the Web page. Web pages and their ranking information are stored in an index which is consulted to find links to Web pages relevant to a keyword employed in a search request.

Another example is disclosed in U.S. Patent Application No. 2006/0136405, published on Jun. 22, 2006. The patent describes an apparatus and method which are provided for improving database searching. The apparatus comprises means for accessing a predetermined set of documents containing a plurality of keywords during a learning phase. The apparatus further comprises analyzing means, which is arranged to analyze the documents and to identify, according to predetermined rules, groups of related keywords therein. The apparatus further comprises attribute assigning means arranged to assign attributes indicative of relevance to the groups of keywords, and user profile storing means arranged to store the relevance attributes as a user profile.

However, since the keywords are the basis for the aforementioned electronic searches and the retrieval process, using irrelevant keywords in the query generates an undesirable result list even when using a user-adjusted search or other improved searches, as described above. Undesirable search outcomes may be a result of lack of awareness of the methodology or the terminology of the field of the searched data. Other reasons for such an outcome are linguistic difficulties. Familiarity with the terminology of a certain field in one language may not provide the user with the ability to accurately define a search using certain keywords. Such difficulties are widespread in professional searches such as legal or medical searches.

There is thus a widely recognized need for, and it would be highly advantageous to have, an automatic or semi-automatic search system and method devoid of the above limitations.

### SUMMARY OF THE INVENTION

According to one aspect of the present invention there is provided a device for managing search query keywords. The device comprises an associative memory, wherein the associative memory is configured for recording the usage in keywords of at least one search query, each one of the keywords being associated with at least one document responsive to the at least one search query. The device is configured for managing access to the keywords according to the at least one document.

Preferably, the associative memory is configured for storing user related information in association with the keywords, the user related information being related to users submitted the at least one search query.

Preferably, the keyword is a member of the group consisting of: a word, a string of words, a number, a term, a sentence, a phrase, a trademark, a file name, a URL, an IP address, a term, a phrase, a link, and a string of keywords that comprise number of logical relationship between them.

Preferably, the device further comprises a managing agent, wherein the managing is done using the managing agent.

Preferably, the associative memory is coupled to the device.

Preferably, the keywords are associated with related documents of the at least one document, the related documents being accessed by users submitted the at least one search query.

Preferably, the keywords are associated with related documents of the at least one document, the related documents being viewed for a predefined period by users submitted the at least one search query.

Preferably, the usage in keywords of at least one search query is recorded in a plurality of keyword records.

More preferably, the device is configured for updating the plurality of keyword records, according to search queries of network users and receptive responses.

More preferably, each one of the plurality keyword records comprises a keyword occurrences counter.

More preferably, the increment of the keyword occurrences counter is done according to the identity of the user submitting the at least one search query.

Preferably, the device further comprises a retrieving module for transmitting one or more of the search keywords in response to a document identification mark, the retrieved search keywords being associated with a matching document of the at least one document, wherein the matching document are respective to the document identification mark.

More preferably, the document identification mark is part of a response to a new search query.

More preferably, the document identification mark comprises one member of the group consisting of: a Uniform Resource Locator (URL) address, an internet protocol (IP) address, a computer address, a document checksum, and a network address.

More preferably, the document identification mark is received from a browsing application, and the browsing application is connected via a communication network to the retrieving module.

More preferably, the browsing application comprises a member of the group consisting of: an Internet browser, a searching toolbar, and a file navigator.

More preferably, the associative memory is configured for storing user related information in association with the keywords; the user related information being related to users submitted the at least one search query.

More preferably, the user related information comprises one member of the group consisting of: a user identification mark, a country of origin, navigational data, and time stamp for search query submission, gender, browser information, search-engine information, and the users' age.

More preferably, the access is given according to the user related information.

More preferably, the user related information reflects the distribution of a certain characteristic among the users.

More preferably, the device further comprises an interface connection configured to be connected to a search-engine server, wherein the device is configured to update the plurality keyword records according to search queries submitted to the search-engine server and documents responsive thereto.

Preferably, the device further comprises a search-engine module operative for searching the associative memory according to an indicia.

More preferably, the user application is usable for submitting the indicia to the search-engine module; wherein, keywords responsive to the indicia are transmitted via a communication network to the user application in response to the submission of the indicia.

Preferably, the device further comprises a summary generation module configured for generating at least one document summary of documents of the at least one document according to associated keywords in the associative memory.

Preferably, the device further comprises a page weighting module configured for generating at least one numerical weighting value evaluating the relative importance of a document of the at least one document according to associated keyword of the associative memory.

More preferably, the device further comprises a reverse search module, the reverse search module configured for allowing the retrieval of relevant keywords of the keywords in response to an address of one of the at least one document, the one of the at least one document being associated with the relevant keywords.

According to another aspect of the present invention there is provided a method for facilitating a reverse search, the method comprises several steps: a) receiving a first search query from a network user, b) retrieving at least one document responsive to the first search query, and c) providing at least one keyword previously associated with the at least one document, therewith to allow the network user to refine the first search query.

Preferably, the method further comprises using the keyword in search queries to which the at least one document is responsive to.

Preferably, the method further comprises a step d) of providing information regarding the network users who submitted the search queries.

Preferably, the information comprises one member of the group consisting of: a user identification mark, a country of origin, navigational data, time stamp for search query submission, gender, browser information, search-engine information, and the users' age.

According to another aspect of the present invention there is provided a method for managing search query keywords. The method comprises the steps of:

a) receiving keywords used by search-engine users in a search query, b) storing the usage of each one of the keywords in association with at least one document responsive to the search query, and c) providing independent access to the stored keywords and usage thereof via a communication network.

Preferably the method further comprises steps between step b) and c) of i) receiving a current search query from a network user, and ii) retrieving the at least one document.

Preferably the method further comprises a step iii) of displaying the stored keywords.

Preferably the step of providing of claim 31 comprises a step of allowing the network user to refine the first search query using the stored keywords.

Preferably the independent access is given in response to a new search query; the independent access is given to keywords stored in the associative memory, wherein the keywords are associated with at least one document responsive to the new search query.

Preferably the receiving of step a) further comprises receiving additional information regarding the search-engine users, wherein the storing of step b) further comprises storing the additional information in association with keywords stored in the associative memory and wherein the providing independent access of step c) is extended to the stored additional information.

Preferably, the additional information regarding the search-engine users comprises one member of the group consisting of: a user identification mark, a country of origin, navigational data, and time stamp for search query submission, gender, browser information, search-engine information, and the users' age.

Preferably the method further comprises a step of generating at least one document summery of documents of the at least one document according to associated keywords of the associative memory.

Preferably the method further comprises a step of generating at least one numerical weighting value evaluating the relative importance of a document of the at least one document according to associated keywords of the associative memory.

According to another aspect of the present invention there is provided a system for managing search query keywords used in at least one search query. The system comprises a network accessible associative memory being usable for storing the keywords such that it is associated with documents responsive to the at least one search query, and at least one user application for connecting via a communication network to the associative memory, the user application facilitating the retrieval of at least one chosen keywords of the keywords in response to submitting a document identification mark of document associated with the at least one chose keywords.

Preferably, the network accessible associative memory is configured for updating the stored keywords according to search queries of network users and receptive responses.

Preferably, the document identification mark comprises one member of the group consisting of: a Uniform Resource Locator (URL) address, an internet protocol (IP) address, a computer address, and a network address.

More preferably, the user application comprises a member of the group consisting of: an Internet browser, a searching toolbar, and a file navigator.

Preferably, the network accessible associative memory is configured for storing user related information in association with the keywords, the user related information related to a user who submitted the at least one search query.

More preferably, the user related information comprises a member of the group consisting of: a user identification mark, a country of origin, navigational data, and time stamp for search query submission, gender, browser information, search-engine information, and the users' age.

Preferably, the system further comprises a search-engine server, wherein the network accessible associative memory is configured to update stored keywords according to search queries submitted to the search-engine server and documents responsive thereto.

Preferably, the system further comprises a search-engine module operative for allowing users to use at least one user application for searching the network accessible associative memory according to an indicia.

Unless otherwise defined, all technical and scientific terms used herein have the same meaning as commonly understood by one of ordinary skill in the art to which this invention belongs. The materials, methods, and examples provided herein are illustrative only and are not intended to be limiting.

Implementation of the device, method and system of the present invention involves performing or completing certain selected tasks or steps manually, automatically, or a combination thereof. Moreover, according to actual instrumentation and equipment of preferred embodiments of the device, method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the device, method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of an exemplary keyword managing unit, which is used for managing document search-pattern records, according to a preferred embodiment of the present invention;

FIG. 2 is a schematic illustration of an exemplary system comprising a keyword managing unit, which is used for allowing network users to access document search-pattern records, according to a preferred embodiment of the present invention;

FIG. 3 is a schematic diagram of exemplary database architecture of records in a repository which is part of the keyword managing unit, according to one embodiment of the present invention;

FIG. 4 is another schematic diagram of exemplary database architecture of records in the repository which is part of the keyword managing unit, according to another embodiment of the present invention;

FIG. 5A is an exemplary illustration of a browsing application screen display according to an embodiment of the present invention;

FIG. 5B is another exemplary illustration of a browsing application screen display, according to an embodiment of the present invention;

FIG. 5C is another exemplary illustration of a browsing application screen display, according to an embodiment of the present invention;

FIG. 6 is an exemplary illustration of a browsing application screen display according to another embodiment of the present invention;

FIG. 7 is a flowchart of an exemplary method for managing search query keywords, according to a preferred embodiment of the present invention; and

FIG. 8 is flowchart of an exemplary method for performing a reverse search using the document search-pattern repository, according to a preferred embodiment of the present invention.

### DESCRIPTION OF THE PREFERRED EMBODIMENTS

The present embodiments comprise a device, system or a method, which allow for the improved use of search-engines by creating, maintaining and making available keywords from past searches, and document search pattern data to produce more focused searches. From the user point of view the searcher is able to find a document, find keywords that have been used in the past in association with the document, and use the retrieved keywords to refine his search. The user can also use the retrieved keywords as an indication for the quality of his search.

The principles and operation of a device, system and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A preferred embodiment of the present invention is designed to provide a device for managing document search-pattern records. The device comprises an associative memory, such as a designated repository. The associative memory is configured for recording the usage of keywords in records to enable a user to be able to access keywords used by previous searchers. For example, the user may find a first document of interest and then access keywords that allowed earlier users to find that same document so that the user can now find further documents of interest and focus his search more effectively.

The device comprises an associative memory, such as a designated repository. The associative memory is configured for recording the usage in keywords of search queries such that each keyword is associated with a number of documents which are retrieved in response to the search queries that comprise the keyword. The device is configured for managing access to the associative memory and to the keywords which are stored therein. Preferably each keyword is stored in a designated record in the associative memory. The designated record is associated with related documents, as fully described below.

Another embodiment of the present invention is a method for managing the documenting of search query keywords. During the first step, keywords used by a search-engine user in a search query are received. Then the usage of each one of the keywords is stored in association with documents retrieved in response to the search query comprises one of the keywords. In the following step, independent access and usage thereof is given for the stored keywords, for example to allow later users to make more focused searches. The access is typically given via a communication network.

Another embodiment of the present invention is a system for facilitating access to keywords used in search queries over user networks. The system comprises a network-accessible repository which is usable for storing keywords such that each keyword is associated with documents retrieved in response to the search query for that keyword. The system further comprises user applications which are configured to be connected to the repository via a communication network. Each user application facilitates the retrieval of some of the keywords in response to submitting a document identification mark of a document which is associated with them.

A network entity may be understood as a server, a router, a personal computer, or any other computing unit, which can be used for implementing database management.

A communication network may be understood as the Internet, the Ethernet, a wired or wireless computer network, a local area network, etc.

A keyword may be understood as a word, a number, a term, a sentence, a phrase, a trademark, a file name, a URL, an IP address, a term, a phrase, a link, etc. keyword may also be understood as a string of keywords that comprise number of keywords and number of logical relationship between them.

A document may be understood as a Web page, a file, a WORD document, a PDF document, an XML page, an HTML page, an Internet page, or any other document which is accessible via the communication network.

A document identification mark may be understood as a hyperlink, a Uniform Resource Locator (URL) address, a pointer to a document, a logical address of a document in storage, a relative address of a document in storage, or a reference to a document or other resource.

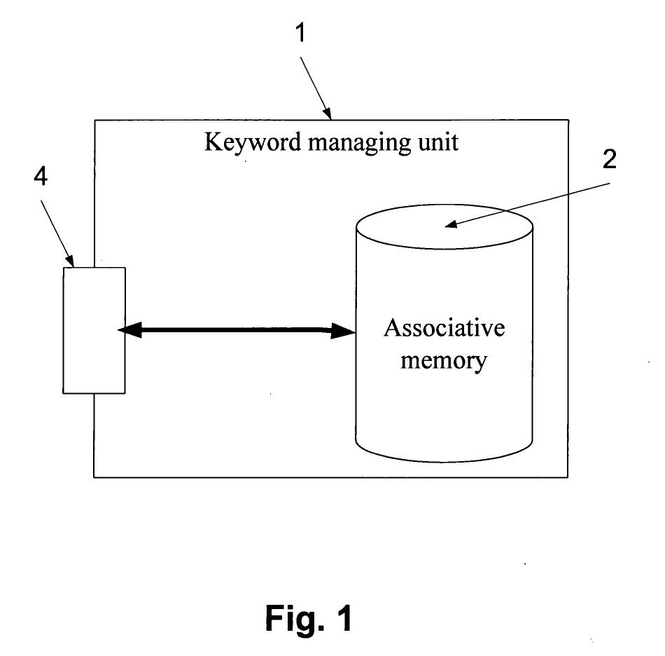

Reference is now made to FIG. 1, which depicts an exemplary keyword managing unit 1 which is used for managing document search-pattern records which are stored in the associative memory 2. The associative memory 2 is configured for documenting the usage of search keywords, preferably in records associated with documents or document identification marks. The associated document identification marks may have been retrieved in response to search queries comprising the related stored keywords. In one embodiment of the present invention, the keyword managing unit 1 further comprises a managing agent. The agent is configured for updating the associative memory 2 according to search queries of network users, as described below. The keyword managing unit 1 further comprises one or more connections 4 that facilitate access to the associative memory 2, as described below. In one embodiment of the present invention the keyword managing unit 1 and the associative memory 2 are coupled

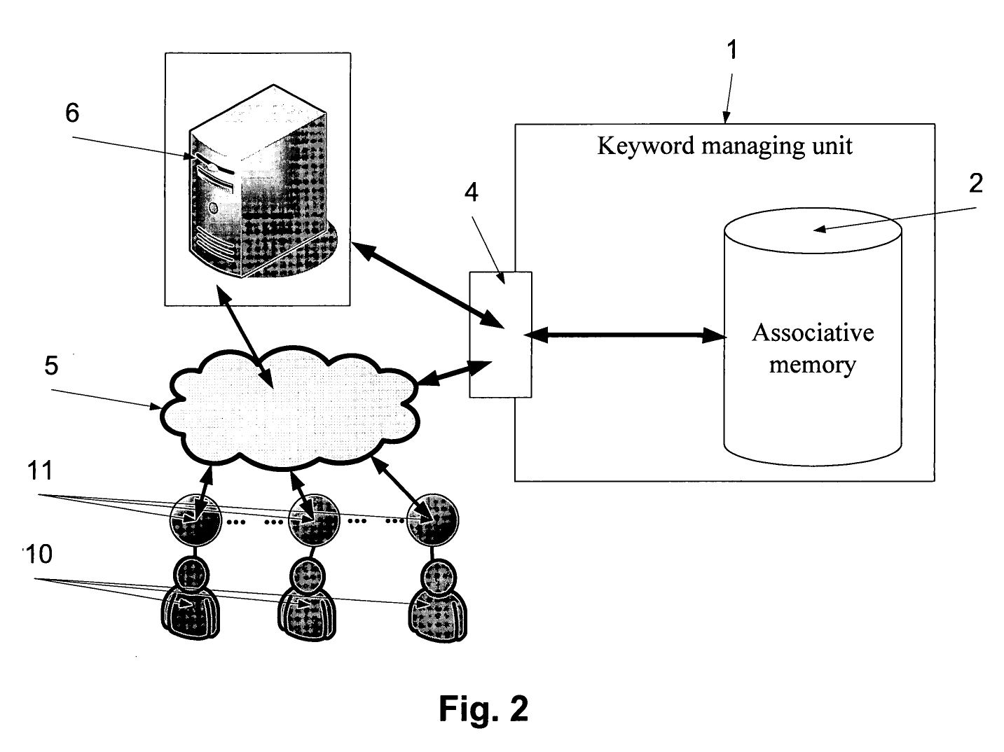

Reference is now made to FIG. 2, which depicts an exemplary preferred embodiment of a system according to the present invention. The keyword managing unit 1 and the associative memory 2 are as in FIG. 1 above. However, in the present embodiment, the keyword managing unit 1 is connected to a communication network 5 and to one or more search-engine servers 6. As depicted in FIG. 2, a number of network users 10 are connected, via the communication network 5, to the keyword managing unit 1. Each one of the network users 10 is connected using a browsing application 11, such as a Web browser or a message delivery program. The browsing application 11 facilitates the establishment of an independent connection with the one or more search-engine servers 6 and with the keyword managing unit 1 via the one or more search-engine servers 6. The independent connection is preferably provided via the communication network 5. In use, the independent connection is, preferably, established with the one or more search-engine servers 6. The search-engine servers 6 are configured to access records which are stored the associative memory 2 either directly or via the keyword managing unit 1. Preferably, the keyword managing unit 1 is integrated with the search-engine servers 6.

In one embodiment of the present invention, the browsing application 11 is a client application which is configured to access the records which are stored the associative memory 2 directly.

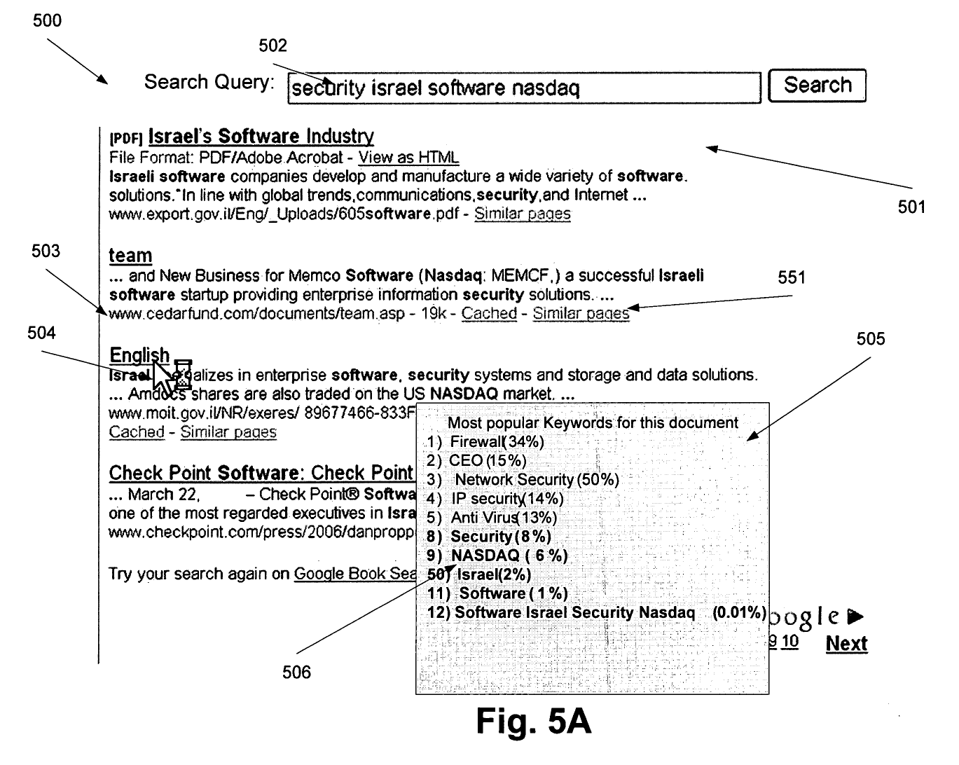

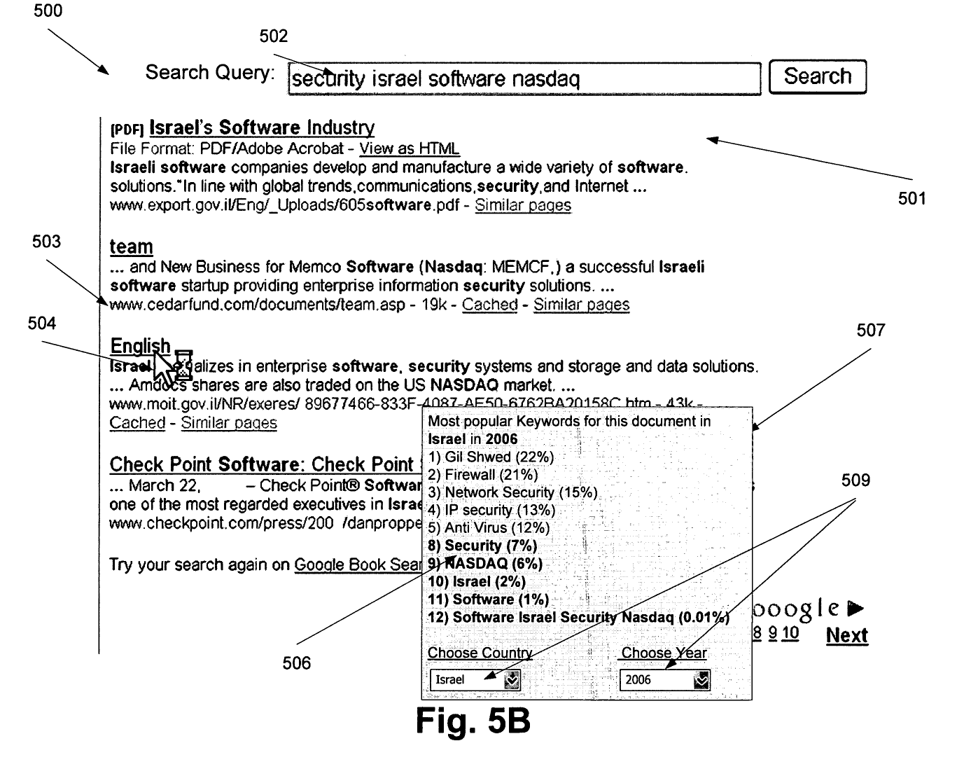

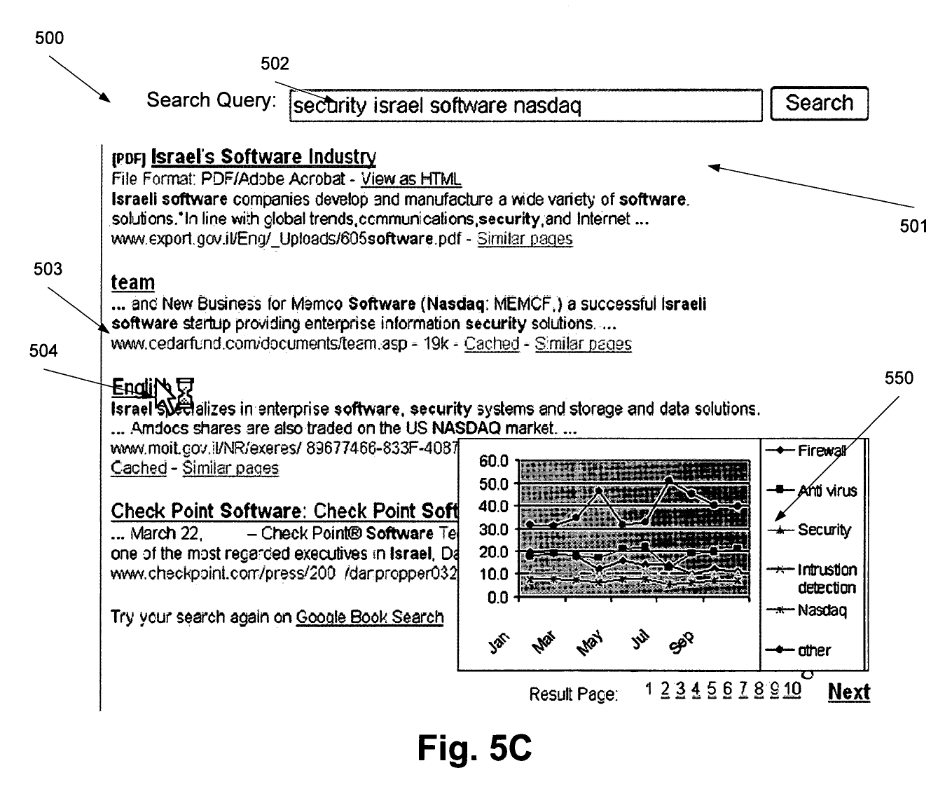

In a preferred embodiment of the present invention, the keyword managing unit 1 is are configured to allow network users 10 to rely on keywords used in different user search queries in order to refine their searches, as further described below and depicted in FIG. 5A. In order to provide users with such ability, the searching activities of different users have to be monitored.

The network users 10 are preferably connected to the communication network 5 using computing units (not shown). Each computing unit may be understood as a personal computer, a personal digital assistant, a mobile telephone, or a laptop. Each computing unit is used for hosting a browsing application 11. In one embodiment, the browsing application 11 is a Web browser such as the Microsoft Internet Explorer™ Web browser. The Web browser allows a user to access any Web page which is available via the communication network 5. As commonly known, each Web page has an address such as a URL address, which is a standard way of specifying the location of an object on the Internet. The Web browser points to the URL of a Web page to receive a related Web page in the hosting computing unit. In another preferred embodiment the communication network 5 is a geographically limited communications network such as a LAN. The communication network 5 may be a communication network of a business entity, such as a Lawyers' office or a company, or a public entity, such as a library or a governmental organization. In such an embodiment the keyword managing unit 1 is used to document the searching activity of local network users 10.

The keyword managing unit 1 is configured to record the searching activity of network users 10 which are connected to the communication network 5 using the browsing applications 11. In one embodiment of the present invention, the keyword managing unit 1 is connected to one or more search-engine servers 6, either directly or via the communication network 5. This connection allows the keyword managing unit 1 to document search queries and documents, which are retrieved in response to the search queries, as described below.

The search-engine server 6, which is connected to the communication network 5 is accessible to user 10 by its IP or URL address and lets the user perform keyword searches for information on the communication network 5. As would be known by any programmer of ordinary skill in the art, a search-engine server includes the following major components: a means to access a collection of documents available over the communication network; an indexing component for building an index of the document collection; and a retrieval (or search) component that, in response to a search query, provides via the index a subset of documents or links that are identified as the search results that are relevant to the query, preferably by some ranking criteria. A document collection typically consists of a certain number of electronic documents of various formats, such as text files, HTML Web pages, or links a link thereto. Large-scale document retrieval systems generally use inverted indices, i.e., indices that record for each keyword (called an index keyword) a list of documents that contains that keyword. Such a list is usually termed an inverted list. Each inverted index consists of many inverted lists, each of which corresponds to a keyword in the index. In many cases, the inverted index may include more information on the frequency, occurrence positions and text formats of each keyword in each document. A document may contain many keywords, and hence may be included in many inverted lists.

Preferably, the search-engine server 6 comprises one or more indices or inverted indices that map the document collection which is available through the computer network 5. As in many common search-engines, when a network user 10 uses the browsing application 11 to access the search-engine server 6 and makes a search query, by giving keywords, the search-engine looks up the index and provides a listing of best-matching documents according to its criteria, usually with a short summary containing the document's title and, sometimes, parts of the text. The search-engine preferably supports search queries that comprises Boolean terms such as AND, OR and NOT which are used to further narrow the search query and other features such as a proximity search, which allows the network user 10 to define the distance between keywords. It should be noted that the manner of performing keyword searching is well known and, hence, will not be described here in detail.

The keyword managing unit 1 is used for recording the keywords in the submitted search query and the documents which are retrieved in response thereto. In one embodiment of the present invention, when a network user 10 uses the browsing application 11 to access the search-engine server 6 and make a search query, the keywords which are used in the search query and the document identification marks which are retrieved in response to the search query are transferred to the managing agent 3 of the keyword managing unit 1. The managing agent documents the keywords in one or more keyword records which are associated with one or more document records, which may be addressed as keyword records hereinafter. The document records comprise document identification marks which then retrieved in response to the aforementioned search query. Preferably, each document, which has been retrieved in response to a particular input search query, is associated with a document record. The document record is associated or linked with one or more keyword records, each of which comprises a keyword used in the certain given input search query. Each keyword record is coupled to a counter that counts the number of occurrences of the related keyword in subsequent search queries in order to reflect the prevalence of the related keyword in different search queries that resulted in retrieving the document which was documented in the associated document record. This information is preferably collected in a dynamic manner, as further discussed below. The collected information allows a network user 10 to refine his search based upon searching activity of other network users, which activity is documented in the associative memory 2. A remotely located network user can receive information from the associative memory 2 that indicates which keywords are usually used for retrieving certain documents, as further described below. Such a process may be regarded as a search in reverse, hereinafter a reverse search, since the keywords are retrieved in response to document identification marks and not the opposite, as in a common search process. In one embodiment of the present invention the associative memory 2 is a designated repository which is used to document the document search-patterns, as explained in greater detail below.

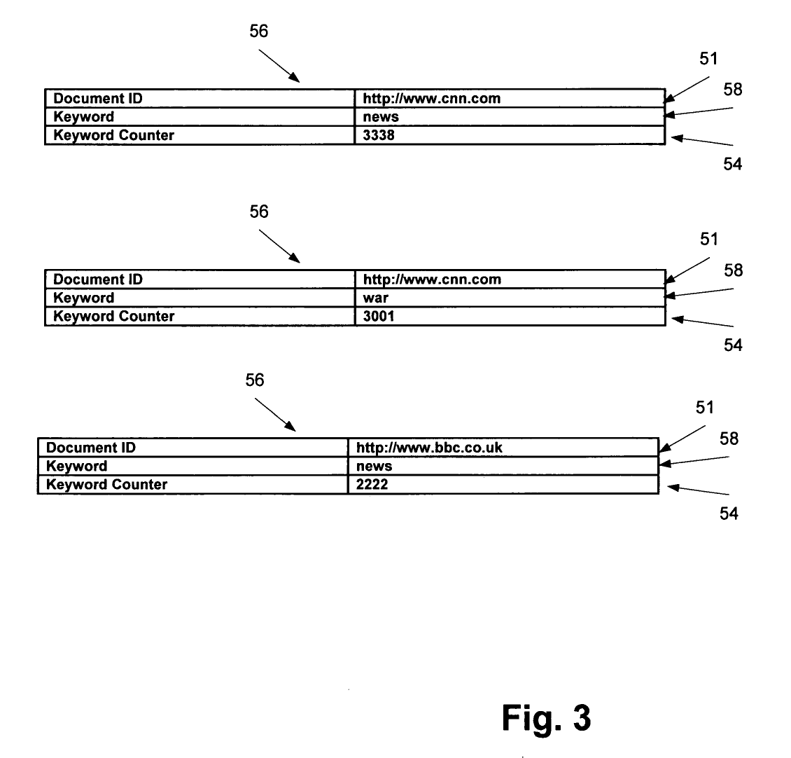

Reference is now made to FIG. 3, which is a diagram of exemplary database architecture of a repository that stores document search-patterns. The repository comprises document and document records which are stored in the document search-pattern repository. As described above, the keyword managing unit or a designated managing agent is configured to receive search queries and retrieved documents and to update the document search-pattern repository accordingly. Preferably, the managing agent is configured for analyzing the received information before it is stored in the document search-pattern repository.

The keywords which are used by the network users are documented in the document search-pattern repository by the managing agent. A list, preferably dynamic, of document records constitutes documents retrieved in response to keywords used by network users during their searches. The exemplary database architecture, which is depicted in FIG. 3, facilitates the creation and maintenance of a document search-pattern repository that documents querying and searching activity of a large number of users. In use, the aforementioned search-engine server 6 (FIG. 2) updates the document search-pattern repository whenever a search query is submitted to the search-engine. The document search-pattern repository is used to store document record 56 which records the number of times a certain keyword which is used in a search query that retrieved a certain document. The document record 56 comprises a document entry 51, a keyword entry 58 and a keyword counter entry 54. The document entry 51 stores a unique identification address of the document such as a URL or any other document identification mark of the retrieved document. Preferably, if the same document is stored in more than one location the checksum of the document or a pointer to another location in which the document is stored can be stored in the document entry 51. The keyword entry 58 records the search query keyword which is used in a search query that retrieved the certain document which is pointed by the document identification mark. The keyword counter 54 records the number of times the search query keyword has been used. For example, as depicted in FIG. 3, the keyword “news” has been used 3338 times in search queries which retrieved the “www.cnn.com” website and 2222 times in search queries that retrieved the “www.bbc.co.uk” website. The keyword “war” has been used 3001 times in search queries that retrieved the “www.cnn.com” website. Clearly, for each search query more than one document record may be generated or updated. If the retrieved document is new, or the search query keyword has been used for the first time in a search query that retrieves a certain document, the document search-pattern repository creates a new document record 56 that record the usage. If the retrieved document is already documented in the database in relation to the used keyword, no new document record 56 is formed. Instead, the value of the related keyword counter data field 54 is increased by one.

Preferably, the document record 56 comprises a validation entry. The validation entry is used to store the last time a certain document record 56 has been updated. Such a validation entry may be used to refresh the repository by deleting document records which have not been updated for a certain period. Optionally a field creation entry may be stored in the document record 56. The creation entry is used to store the creation time of the document record. Such a creation entry may also be used to refresh the repository.

It should be noted that other implementations of the repository are possible. In one embodiment of the present invention, the keyword entry 58 comprises pointers to the data fields of a collective keyword list that comprises all the keywords and terms which have been documented in different search queries. Such an implementation may substantially reduce the required memory storage capacity, thus effectively lowering the storage hardware cost, and greatly increasing the speed of generating and processing keyword records.

Clearly, the number of records in the dynamic document search-pattern repository depends on the number of performed search queries and retrieved documents. The higher the number, the more comprehensive the document search-pattern repository will be.

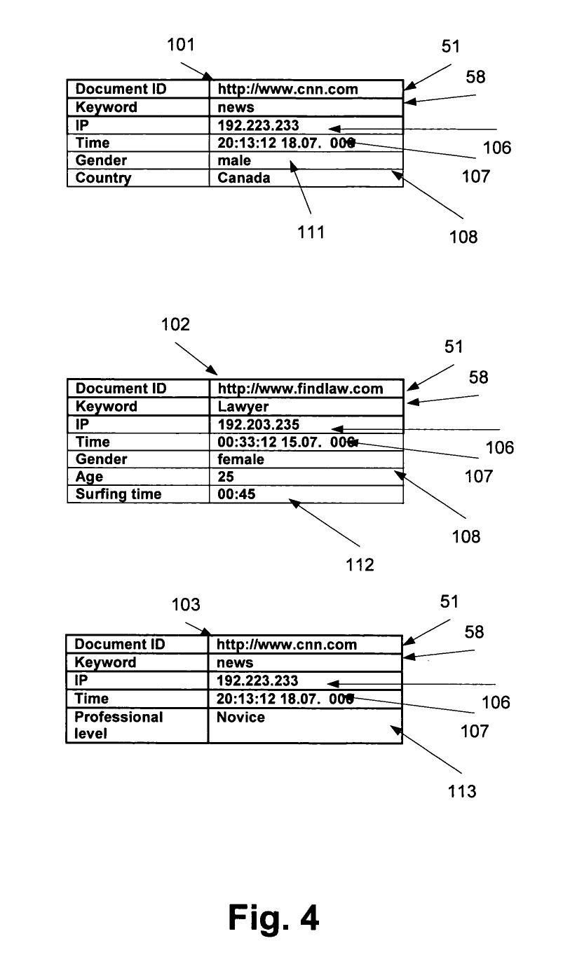

Reference is now made to FIG. 4, which is a diagram of exemplary database architecture of the repository records, according to another embodiment of the present invention. The document entry 51 and the keyword entry data field 58 are as in FIG. 3 above. However, in the present embodiment, the document records 101, 102, 103 comprises additional data fields which are used for recording information about a certain search query that comprises the recorded keyword or about the user that submitted the keyword. FIG. 4 depicts three optional document records 101, 102, 103. As described below, those document records 101, 102, 103 are exemplary and other structures that comprise other attributes entries may be used for documenting the search-pattern information.

As described above, the document search-pattern repository is configured to be dynamically updated according to network users' search queries. Such dynamic updating allows the document search-pattern repository to provide network users with information regarding the frequency of use of different keywords. However, in order to provide more comprehensive information regarding the search-patterns of the stored documents, the document search-pattern repository has to be expanded. In one embodiment of the present invention, as shown in FIG. 4, each document record 101 further comprises a set of attribute entries. Preferably, each one of the attribute data fields comprises information about a certain search query that comprises the recorded keyword or about the user that submitted the search query. The aforementioned managing agent may be used for acquiring the information which is documented in the attribute entries.

Preferably, one of the attribute entries is an IP entry 106 which is used to record the IP of the user that submitted the search query. Other user identification marks such as IP addresses, subscriber names, or email addresses, may be used. Another attribute entry 108 records the country of origin from which the network user accessed the communication network for using the search tool of the search-engine server. This information can easily be tracked as the IP of the network user is available and mostly its origin is generally indicative of the country.

Preferably, one of the attribute entries is a time stamp entry 107 that documents the time in which each network user accessed the communication network for using the search tool of the search-engine server. This information can easily be tracked as a clock-based module that can be used to indicate the exact time each network user accessed the search-engine server. Preferably, time adjustments are made in order to adjust the access hour according to the time zone of each user. The time zone can be identified according to the IP address that reflects the country of origin, as described above. It should be noted that a different time intervals may be documented. Such time intervals may be daily hours, seasons, months, or days of the week. Relative time or local time may be used.

The attribute entries may also be used for recording user-related information. Such information may be documented if the search-engine server or the keyword managing unit has more information about the network user that submits the search query. Examples of attribute lists that document keyword usage in search queries that retrieve the related document are presented in FIG. 4. One exemplary attribute entry 111 records the gender of the network user. Another exemplary document record 102 comprises an attribute entry 109 that records the age of the network user. Other user characteristics, such as acquired education, family status, specialties, profession, etc., can also be documented using corresponding attribute entries. Preferably, a subscriber database which is accessible to the managing agent is connected to the communication network. The subscriber database stores records of user-related information. In a preferred embodiment of the invention, the managing agent scans the subscriber database for identifying a certain record that matches the querying user. Then, the managing agent uses the user-related information which is stored in the document records to update the user-related information in the document search-pattern repository.

As described above, the keyword managing unit is configured for documenting information about the network users. As further described above, the keyword managing unit is configured for allowing different users to submit search queries. One embodiment of the present information allows the differentiating between different search queries which are submitted by different users. In such an embodiment, keywords of search queries which have been submitted by certain users may be given with more weight than keywords of search queries which have been submitted by others. Users may be divided into different groups; each group preferably represents different professional level. For example, users may be divided to novice searchers, average searchers, and professional searchers. In such an embodiment the records of the document search-pattern repository are updated according to the user professional level. For example, if a novice user used a certain keyword in a search query, the counter which is associated with the keyword is increased by one. However if a professional user used the same word in a search, the counter is increased by 3. In order to implement such an embodiment the document record 103 may comprise an attribute entry 113 that stores the professional level of the user.

Preferably, the document record 101 comprises attribute entries which record navigational data. Navigational data includes log files and click stream data. Navigational data can identify a user's Web browser and operating system, when and for how long a user visits a certain Website, what pages a user views on a Website, and the address of the Website that the user visited immediately prior to that Website. This information is typically used to administer a Website, improve Website content, and compile aggregated statistics for marketing and research purposes. The navigational data may be collected on the server side by examining Web server page request logs or on the client side by monitoring user surfing patterns using, for example, a designated add-in. Such information can better reflect the relevance of the associated document to the keyword which was used in the search query in which it was retrieved. Clearly, a certain document which a user spent a significant amount of time viewing, or users spend time, or a website in which users a certain Website in which a user viewed a large number of pages, is more relevant to the keyword which was used in the search query that retrieved it than a document or Website which was viewed only briefly. Thus, documenting the navigational data may allow the user to rely on better information when conducting his search. Moreover, by using the navigational data one can avoid misleading keywords. Even if a certain keyword was used for a particular document in a large number of search queries, the related navigational data indicates that the keyword is not relevant to the particular document since users did not utilize the retrieved document.

In one embodiment of the present invention the document record 102 comprises an attribute entry 112 that records the time a certain network user stays in the related Website which is pointed by the document entry 51. Such information can be acquired by different calculations which are based on navigational data which is related to the user. Preferably, the time a certain network user stays in the related Website is updated by an external source which is designated for acquiring such information. Another preferred attribute entry documents the average number of pages the user visits in the related Website.

Since the document records 101 records all the keywords which are used in different search queries. As described above, the total amount of search queries that uses a certain keyword to retrieve a certain document can easily be calculated.

Reference is now made to FIG. 5A, which is an exemplary illustration of a screen display and an interface of a user application, according to an embodiment of the present invention. As described above, the keyword managing unit 1 is configured, inter alia, to provide network users with statistical information regarding the keywords which are used to retrieve different documents which are available via the communication network. In one embodiment of the present invention, the keyword managing unit 1 is configured to provide network users with the information via browsing applications which are hosted on computing units connected to the communication network. The information can be provided either directly or via a search engine server.

FIG. 5A depicts a display 500 of a Web page of a search-engine with a graphical user interface (GUI) and a search result list 503. The GUI allows a user to submit search queries to one or more search-engine servers. The GUI displays a text box 502 that allows a user to interface with the search-engine, inputting keywords that comprise the search query for which the search-engine is to look. The GUI further displays a search result list 503 that preferably displays titles of the documents which match the user's input search query, and preferably a short description thereof. As described above, a mouse is connected to the hosting computing unit allows the user to move an input pointer 504 over the display and to make selections. The display 500 is configured to allow the user to control the search-engine tasks. In use, a user can enter keywords that presumably describe the information or document he or she wants to find into the text box 502 and hit the ‘Enter’ key or click on a designated search button to initiate the search. Then, the search-engine performs a search according to the used keywords. Subsequently, the search-engine retrieves links 501 to the documents that match the user's search query. The search-engine generates a search result list 503 that comprises generated links 501. Each link 501 facilitates access to the documents which are retrieved by the search-engine according to the user's request. The generated links 501 of the search result list 503 allow the network user to choose a specific document, preferably by clicking the input pointer 504 over one of the links 501. Each one of the generated links 501 allows the user to initiate the downloading of a related document to the hosting computing unit of the browsing application via the communication network. It should be noted that the manner of displaying the GUI and the search result list 503 are well known and hence will not be described here in detail.

The display 500 is further configured to display in parallel relevant document search-pattern information which is stored in an associative memory such as the aforementioned document search-pattern repository. Preferably, the keyword managing unit is configured to receive one or more document identification marks and, accordingly, to retrieve one or more sets of related keywords and additional related information. Preferably, the keyword managing unit is configured to retrieve the most prevalent keywords which are used for retrieving the document. In one embodiment of the present invention, the user application is configured to display a pop-up window 505 that is configured to show relevant statistical document search-pattern information, when available, about the retrieved documents that comprise the search result list 503. Preferably, the pop-up window 505 is automatically displayed when the input pointer 504 is moved over one of the links, or when a designated button is pressed. Preferably, when the input pointer is moved over one of the links, a related document identification mark is sent to the keyword managing unit. The keyword managing unit retrieves matching keywords and preferably additional information. The retrieved keywords are presented in the pop-up window, as depicted at 506.

As shown in the exemplary display of FIG. 5A, the pop-up window 505 may be configured to display statistical information about the different keywords in the search queries which have been used to retrieve the documents that comprise the search result list 503. Preferably, upon using the mouse for clicking on a link that comprises the search result list 503, the pop-up window 505 appears. The pop-up window 505 preferably presents dozens of related keywords, preferably arranged according to their prevalence in the document accessible via that link. The display is based upon a list of related keywords which are associated with the document which is indicated by the input pointer 504.

As described above, other document search-pattern information is stored in the associative memory. In use, the additional information may also be displayed in parallel in the pop-up window 505 or, if desired, in a separate pop-up window, as per the user's requirements. Preferably, the keywords 506 which are displayed in the pop-up window 505 and were submitted in text box 502 are displayed in bold letters. Such a display facilitates the user to distinguish between words that he already uses to words that might assist him to refine his search. Preferably, the user can move the input pointer 504 over one of the displayed keywords 506 and click on it in order to add it to his search query. A search according to the new search query that comprises the selected keyword may be preformed automatically after the selected keyword has been clicked on.

In one embodiment of the present invention, the links of the search result list 503 are arranged according to the prevalence of keywords, which were submitted in searches retrieving the linked document in the past, and are currently submitted in text box 502. As commonly known, elements of search result lists are usually arranged according to numerical weighting methods which are used for evaluating the relative importance of elements that comprise the list. Usually, each element of a hyperlinked set of documents, such as the World Wide Web, is weighted for the purpose of measuring its relative importance within the set. Such methods may be applied to any collection of entities with reciprocal quotations and references. An example of such a numerical weighting method is the PageRank method by Google™.

Preferably, the links that comprise the search result list 503 are arranged not only by their numerical weight, but also by their prevalence in search result lists, which were generated according to previous searches comprising one or more of the keywords, used in generating the search result list 503. Such an embodiment can be implemented by accessing related records in the associative memory. As described above, an associative memory such as the document search-pattern repository preferably comprises records of documents or document identification marks. Each record is associated with entries that reflect the prevalence of different keywords in search queries retrieving the document stored or marked in the associated record.

Preferably, the numerical weight of links of the search result list 503 is determined by matching keywords used in the search query which is currently submitted by the user with document records that reflect the prevalence of different keywords in search queries retrieving the linked document. The higher the prevalence of the matched keywords in search queries retrieving the linked document, the higher the given numerical weight.

In one embodiment of the present invention, the records of the associative memory are used for identifying similar documents. As commonly known, some search engines allows users to access similar pages by clicking on a designated link. When the user selects the link for a particular result of the result list, the search engine automatically scouts the Web for pages that are related to this result. In the present invention, when the user selects such a link 551 for a particular result of the result list a related document identification mark is sent to the document search repository, preferably via the search engine, and similar documents are scouted based upon related records of the document search pattern repository are retrieved. For example, the time stamp of the document record, as described above, may be used to find similar pages. Documents which are accessed by the same user, approximately at the same time, can be estimated as similar documents. The similar documents may be documented offline or online. The retrieved similar documents can be chosen according to the information which is documented in the document records. For example, a common user which is documented in the IP entries, a common age group, or the combination thereof.

As described above, user applications may be used for accessing the associative memory, which is part of the keyword managing unit, for downloading related records, as described above. Such ability allows the users to use the information stored in the associative memory to refine their searches. For example, in FIG. 5A, a list of keywords, which is associated with a document of a search result list, is downloaded and presented in parallel to the list itself. The ability to download records from the document search-pattern repository may be used to receive information regarding documents in other applications.

As described above, the pop-up window 505 is configured to display a list of keywords according to their usage in previous searches that retrieved the related document. The list of keywords indicates the prevalence of each one of the list's keywords in previous searches. In one preferred embodiment, the pop-up window 505 is configured to display a list of keywords which is a conjunction of two or more lists of keywords which are each associated with different documents. In such an embodiment the user can chose two or more retrieved document from the search result list 503. The keyword managing unit receives two or more respective document identification marks and generates for each one of them a list of keywords, as described above. Than the keyword managing unit chooses keywords with the highest number of occurrences in the sum of the occurrences from each one of the two lists of keywords. In another embodiment of the present invention, this process is done automatically as a list of keywords which is a conjunction of two or more lists of keywords is produced for a predefined number of documents in each search result list. For example, such a list of keywords may be automatically produced for the portion of the search result list which is currently displayed on the screen.

In another preferred embodiment the list of keywords is displayed in a diagram such as a graph or a chart. The diagram may be used for displaying a series of points or lines to demonstrate a connection between two or more attributes. For example, as depicted in FIG. 5C, the diagram 550 is used for depicting the usage in keywords for retrieving the related document, which is pointed by the mouse pointer 504, in different time intervals. The information which is depicted in the graph can be deduced from analyzing the records of the document search-pattern repository.

In another embodiment of the present invention, the keyword managing unit allows users to refine their searches using keywords which have been used by a certain user or group of users which are, preferably, from a common location or part of the same department. As described above, each document record may comprise an IP entry that records the IP of the user that submitted a related search query. Preferably, the keyword managing unit can retrieve the keywords a certain user used in a search query for retrieving a certain document.

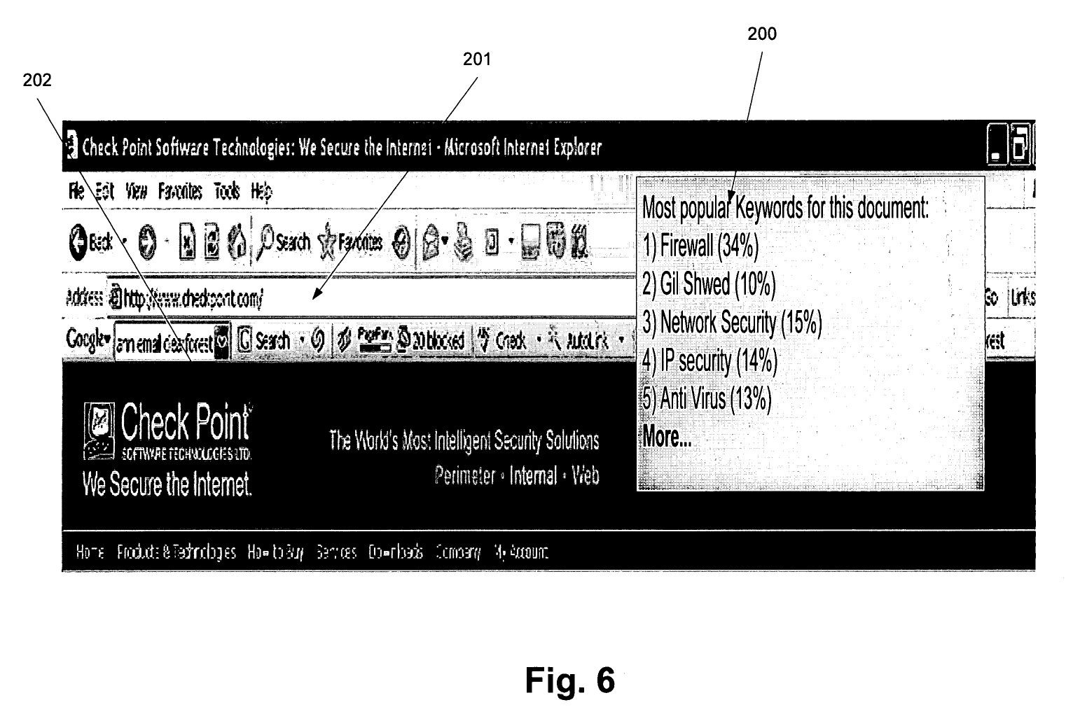

Reference is now made to FIG. 6, which is an exemplary illustration of a screen display and an interface of a user application, according to another embodiment of the present invention. In one embodiment of the present invention, the user application may be a browsing application such as an Internet browser, a searching toolbar, or a file navigator. Preferably, a designated module, such as an add-in program, is integrated into the browsing application. The designated module has the ability to access the repository via the keyword managing unit. In such an embodiment, a list 200 of keywords, related to the document which is currently accessed by the browsing application 202, may be presented, preferably as a pop-up window when the mouse pointer is moved over the Address Bar 201. The presentation is preferably done as described in connection with FIG. 5A.

In another embodiment of the present invention, the keyword managing unit may further comprise a search-engine module. The search-engine module is preferably configured to search the associative memory, using the keyword managing unit, according to a received search query or index. As described above, the associative memory documents querying information that is associated with different documents which are accessible via the communication network. An exemplary structure of the relationship between records that are stored in an associative memory such as the document search-pattern repository is depicted in FIGS. 3 and 4. As described above, the document search-pattern repository comprises information regarding the prevalence of keywords in search queries, preferably in association with demographic and other user-related information. The integrated search-engine module may be used for allowing a user to search the associative memory by inserting search queries. In order to allow the user to have the ability to input a search query, the user application comprises a search GUI. The search GUI displays a user input interface such as a string field or a scrolling list of words. The user input interface allows the user to interface with the search-engine module and to input and refine the search query. Preferably, the search query is in SQL format. The search-engine module searches for a full or a partial match between the search query and records of the repository, creating a result list based upon the match. In an embodiment of the present invention, the search query module allows a user to search the document search-pattern repository according to statistical criteria. For example, the user can search for the most popular keyword which is used by females and retrieves a certain document. In another example, the user check what are the most popular keywords entered by users in the age group of 15-25 and retrieves a predefined group of documents relating to aero-modeling. Preferably, the user can delimit a certain period of time in which the keywords where used. FIG. 5B depicts an exemplary designated pop-up window 507 with adjusted toggle boxes 509 which are configured to allow users to submit such search queries.

As described above, the information, which is accumulated in the associative memory which is connected to the keyword managing unit, reflects the behavior of a network user. As such, the keyword managing unit using the search-engine module can be used as an analytic tool for analyzing the behavior and search patterns of network users. Such an analytic tool can be used in academic and commercial studies. For examples, advertisers, Website administrators and promoters can utilize the database to identify which keywords are used to retrieve certain documents in order to improve their traffic, search-engine ranking, and Web presence. For instance, advertisers can use the keyword managing unit to improve their website hit rate by identifying which keywords are commonly used for retrieving their website and websites which are related to their service or product. Moreover, the keyword managing unit may be used to identify which demographic groups retrieve their website or websites which are related to their service or product. In addition, the keyword managing unit may be used to identify which segment of the population uses which words for searching their website or websites which are related to their service or product. Such information can be highly beneficial for improving marketing activities.

Psychological information can be gathered and analyzed according to the statistical information which is gathered, as aforementioned, in the database.

One embodiment of the present invention is related to the generation of document summaries in search result lists. As commonly known, search result lists include individual entries that have been identified by the search-engine as satisfying the user's search expression. Each entry includes a hyperlink that points to a URL location or a Web page. In addition to the hyperlink, certain search result pages include a short document summary that describes the content of the URL location. Typically, search-engines generate this document summary from the file at the URL, and only provide acceptable results for URLs that point to HTML format documents. For URLs that point to HTML documents or Web pages, a typical document summary includes a combination of values selected from HTML tags. These values may include a text from the Web page's “title” tag, from what are referred to as “annotations” or “meta tag values” such as “description,” “keywords,” etc., from “heading” tag values (e.g., H1 or H2 tags), or from some combination of the content of these tags. Some search-engines generate the document summary according to matches between document features such as the HTML tags and the keywords that comprise the search query that initiate the retrieval of the summarized document. However, it is noted that search query keywords may not always accurately reflect the content of the summarized document and such a summary may, therefore, mislead the user.

In one embodiment of the present invention, the records of the associative memory are used for generating a summery of an associated document. As described above, the associative memory comprises documentation of the keyword usage in connection with different documents which are retrieved in response to search queries that comprise related keywords. Preferably, during the document summary generation, the generating module of the search-engine accesses the associative memory using the keyword managing unit. This allows the generating module to use keywords which are stored in association with related document records instead of keywords which comprise the user's search query. Preferably, only the most common keywords are used for generating the document summary. For instance, in the example depicted in FIG. 5A, the user input the words “security”, “Israel”, “software”, and “NASDAQ”. However, as implied at the pop-up window, the word “Firewall” and the term “Network security” were used by more users in search queries that retrieved the related document. By using the keywords which were used by larger numbers of users, it is presumed that the summery will be generated in a manner that reflects the document more accurately.

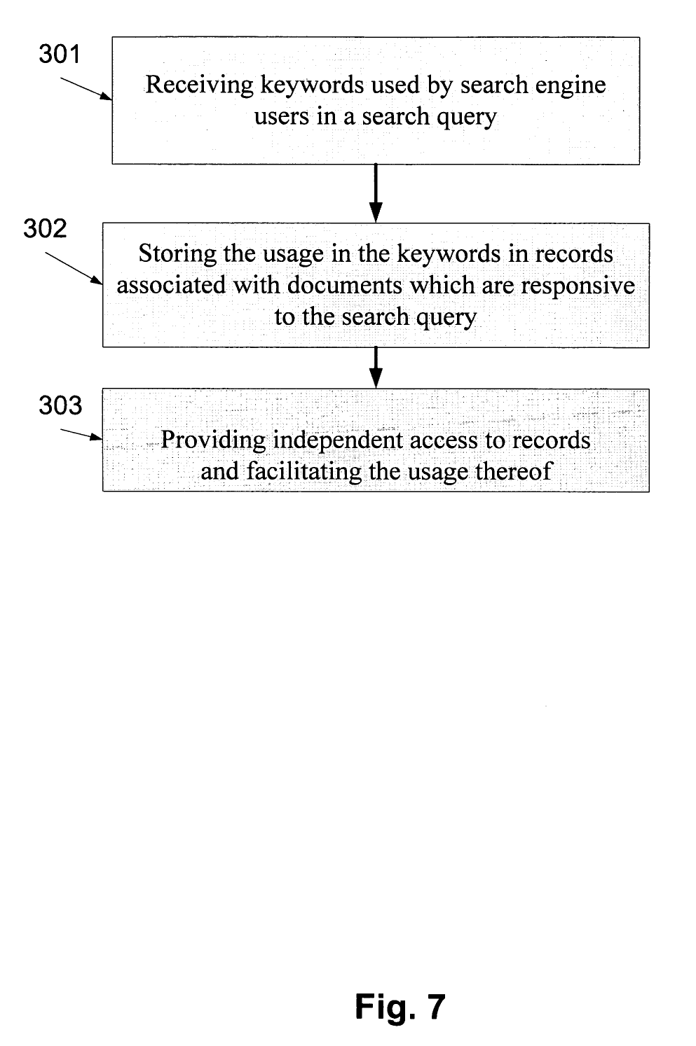

Reference is now made to FIG. 7, which is a flowchart of an exemplary method for managing the documenting of search query keyword usage according to a preferred embodiment of the present invention. In the first step, as shown at 301, keywords of a search query, which are used by a search-engine user, are received. The keywords can be received directly from the search-engine server, as described above, or directly from the user applications which is used for submitting the search query. In one embodiment, additional information regarding the search query or the user that submitted the search query is received. Such additional information may comprise the user's gender, the user's age, the user's country of origin, the time the search query was submitted, the browser the user used to submit the search query, the search-engine which the user used to submit the search query, or navigational data regarding the user who submits the search query. The designated records are used for documenting the keyword usage. In one embodiment of the present invention, each designated record that represents a certain keyword is provided with a counter. The value of the counter is incremented each time a search query that comprises the related keyword is received. Such a counter may also be added to records which are used to document the additional information which is related to the keyword.

Then, as shown at 302, the usage of each one of the keywords is stored in the associative memory, preferably in designated records. The designated records are associated with one or more documents which are retrieved in response to the search query. If additional information is received, it is stored in association with the keywords of the search query. An exemplary database structure is disclosed explained in detail hereinabove. In the following step, as shown at 303, independent access to the designated records and the ability to use them is provided to the user via a communication network. If additional information is stored, access is given thereto as well. Preferably, the user can use user applications, as described above, to access the designated records which are stored in the associative memory using the keyword managing unit.

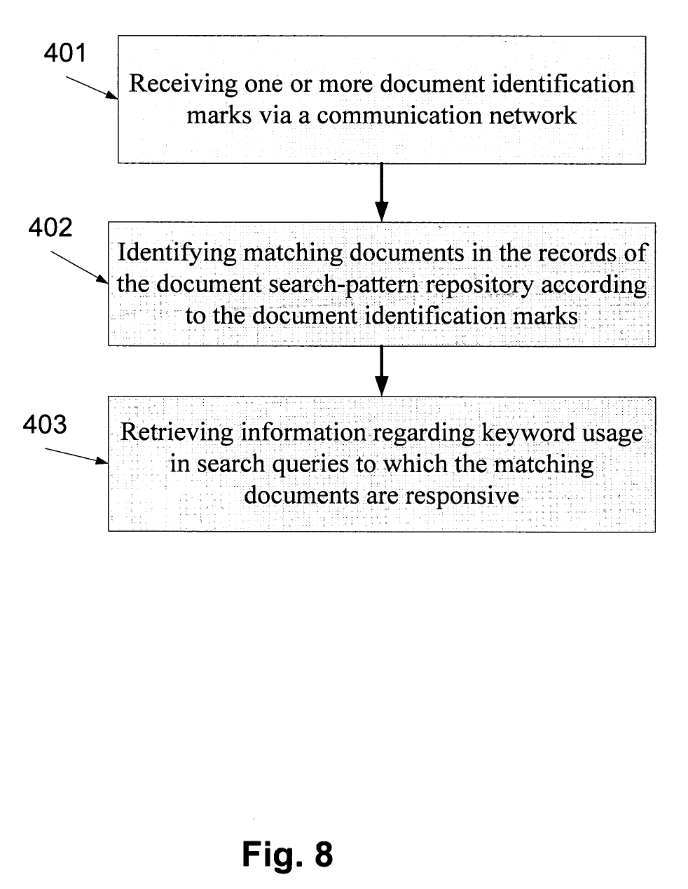

Reference in now made to FIG. 8, which is a flowchart of an exemplary method for performing a reverse search using documentation of search query keywords, according to a preferred embodiment of the present invention. As described above, the associative memory is used for documenting the usage of keywords. Preferably, as described above, keywords used in particular search queries are stored in records which are associated with documents retrieved in response to particular search queries. In order to allow a user to refine his search according to information which is stored in the associative memory, the associative memory is configured to receive matching instructions. In the first step, as shown at 401, matching instructions are received via the communication network. In one embodiment of the present invention, the matching instructions comprise one or more document identification marks such as URLs. In the following step, as shown at 402, the received document identification marks are matched with records of the associative memory. As described above, each document, which is documented in the associative memory, is associated with keywords that are used in search queries in response to which it is retrieved. As further noted, each keyword is associated with data fields that document its prevalence and other related information such as user-related information. Such database architecture facilitates, in the following step, the retrieval of information regarding keyword usage, as shown at 403. Preferably, the associated keywords are retrieved based on the received document identification marks. In one embodiment of the present invention, the matching instructions further comprise limiting criteria such as the gender or the age of the user. In such an embodiment, only information regarding keywords submitted by users who meets the limiting criteria is retrieved. The analysis which is made to determine which records meet the limiting criteria is based upon the attributes which are associated with the records, as described above.

It is expected that during the life of this patent many relevant devices and systems will be developed and the scope of the terms herein, particularly of the terms search-engine, server, Website, Web page, communication network, and user application are intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Reference is now made, once again, to FIG. 1. In one embodiment of the present invention, the keyword managing unit 1 is a server. An example of a server suitable for use with the present invention is an Intel Pentium based computer system having the following characteristics: 1024 MB RAM, two 500 GB hard drives, and network server connectivity. In the present invention, the server preferably provides similar functionality to the Microsoft Windows NT Server Suite. Clearly, the size of the required memory is a derivative of the number of the document records, where approximately 1000 Bytes are needed for each document which is documented in the repository.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed:

1. A device for managing search query keywords, said device comprising:
an associative memory, wherein said associative memory is configured for recording the usage in keywords of at least one search query, each one of said keywords being associated with at least one document responsive to said at least one search query; and
wherein said device is configured for managing access to said keywords according to said at least one document.

2. The device of claim 1, wherein said keyword is a member of the group consisting of: a word, a string of words, a number, a term, a sentence, a phrase, a trademark, a file name, a URL, an IP address, a term, a phrase, a link, and a string of keywords that comprise number of logical relationship between them.

3. The device of claim 1, further comprising a managing agent, wherein said managing is done using said managing agent.

4. The device of claim 1, wherein said associative memory is coupled to said device.

5. The device of claim 1, wherein said keywords are associated with related documents of said at least one document, said related documents being accessed by users submitted said at least one search query.

6. The device of claim 1, wherein said keywords are associated with related documents of said at least one document, said related documents being viewed for a predefined period by users submitted said at least one search query.

7. The device of claim 1, wherein said the usage in keywords of at least one search query is recorded in a plurality of keyword records.

8. The device of claim 7, wherein said device is configured for updating said plurality of keyword records, according to search queries of network users and receptive responses.

9. The device of claim 7, wherein each one of said plurality keyword records comprises a keyword occurrences counter.

10. The device of claim 9, wherein the increment of said keyword occurrences counter is done according to the identity of the user submitting said at least one search query.

11. The device of claim 1, further comprising a retrieving module for transmitting one or more of said search keywords in response to a document identification mark, said retrieved search keywords being associated with a matching document of said at least one document, wherein said matching document are respective to said document identification mark.

12. The device of claim 11, wherein said document identification mark is part of a response to a new search query.

13. The device of claim 11, wherein said document identification mark comprises one member of the group consisting of: a Uniform Resource Locator (URL) address, an internet protocol (IP) address, a computer address, a document checksum, and a network address.

14. The device of claim 11, wherein said document identification mark is received from a browsing application, and said browsing application is connected via a communication network to said retrieving module.

15. The device of claim 14, wherein said browsing application comprises a member of the group consisting of: an Internet browser, a searching toolbar, and a file navigator.

16. The device of claim 1, wherein said associative memory is configured for storing user related information in association with said keywords, said user related information being related to users submitted said at least one search query.

17. The device of claim 16, wherein said user related information comprises one member of the group consisting of: a user identification mark, a country of origin, navigational data, time stamp for search query submission, gender, browser information, search-engine information, and said users' age.

18. The device of claim 17, wherein said access is given according to said user related information.

19. The device of claim 17, wherein said user related information reflects the distribution of a certain characteristic among said users.

20. The device of claim 7, further comprising an interface connection configured to be connected to a search-engine server, wherein said device is configured to update said plurality keyword records according to search queries submitted to said search-engine server and documents responsive thereto.

21. The device of claim 1, further comprising a search-engine module operative for searching said associative memory according to an indicia.

22. The device of claim 21, wherein a user application is usable for submitting said indicia to said search-engine module; wherein, keywords responsive to said indicia are transmitted via a communication network to said user application in response to the submission of said indicia.

23. The device of claim 1, further comprising a summary generation module configured for generating at least one document summary of documents of said at least one document according to associated keywords in said associative memory.

24. The device of claim 1, further comprising a page weighting module configured for generating at least one numerical weighting value evaluating the relative importance of a document of said at least one document according to associated keyword of said associative memory.

25. The device of claim 24, further comprising a reverse search module, said reverse search module configured for allowing the retrieval of relevant keywords of said keywords in response to an address of one of said at least one document, said one of said at least one document being associated with said relevant keywords.

26. A method for facilitating a reverse search, comprising:
a) receiving a first search query from a network user;
b) retrieving at least one document responsive to said first search query; and
c) providing at least one keyword previously associated with said at least one document, therewith to allow said network user to refine said first search query.

27. The method of claim 26, further comprising using said keyword in search queries to which said at least one document is responsive to.

28. The method of claim 27, further comprising a step d) of providing information regarding the network users who submitted said search queries.

29. The method of claim 28, wherein said information comprises one member of the group consisting of: a user identification mark, a country of origin, navigational data, time stamp for search query submission, gender, browser information, search-engine information, and said users' age.

30. A method for managing search query keywords, comprising:
a) receiving keywords used by search-engine users in a search query;
b) storing the usage of each one of said keywords in association with at least one document responsive to said search query; and
c) providing independent access to said stored keywords and usage thereof via a communication network.

31. The method of claim 30, further comprising steps between step b) and c) of
i) receiving a current search query from a network user; and
ii) retrieving said at least one document.

32. The method of claim 30, further comprising a step iii) of displaying said stored keywords.

33. The method of claim 30, wherein said providing of claim 31 comprises a step of allowing said network user to refine said first search query using said stored keywords.

34. The method of claim 30, wherein said independent access is given in response to a new search query, said independent access is given to keywords stored in said associative memory, wherein said keywords are associated with at least one document responsive to said new search query.

35. The method of claim 30, wherein said receiving of step a) further comprises receiving additional information regarding said search-engine users, wherein said storing of step b) further comprises storing said additional information in association with keywords stored in said associative memory and wherein said providing independent access of step c) is extended to said stored additional information.

36. The method of claim 35, wherein said additional information regarding said search-engine users comprises one member of the group consisting of: a user identification mark, a country of origin, navigational data, time stamp for search query submission, gender, browser information, search-engine information, and said users' age.

37. The method of claim 29, further comprising a step of generating at least one document summery of documents of said at least one document according to associated keywords of said associative memory.

38. The method of claim 29, further comprising a step of generating at least one numerical weighting value evaluating the relative importance of a document of said at least one document according to associated keywords of said associative memory.

39. A system for managing search query keywords used in at least one search query, said system comprising:
a network accessible associative memory being usable for storing said keywords such that it is associated with documents responsive to said at least one search query; and
at least one user application for connecting via a communication network to said associative memory, said user application facilitating the retrieval of at least one chosen keywords of said keywords in response to submitting a document identification mark of document associated with said at least one chose keywords.

40. The system of claim 39, wherein said network accessible associative memory is configured for updating said stored keywords according to search queries of network users and receptive responses.

41. The system of claim 39, wherein said document identification mark comprises one member of the group consisting of: a Uniform Resource Locator (URL) address, an internet protocol (IP) address, a computer address, and a network address.

42. The system of claim 41, wherein said user application comprises a member of the group consisting of: an Internet browser, a searching toolbar, and a file navigator.

43. The system of claim 39, wherein said network accessible associative memory is configured for storing user related information in association with said keywords, said user related information related to a user who submitted said at least one search query.

44. The system of claim 43, wherein said user related information comprises a member of the group consisting of: a user identification mark, a country of origin, navigational data, time stamp for search query submission, gender, browser information, search-engine information, and said users' age.

45. The system of claim 39, further comprising a search-engine server, wherein said network accessible associative memory is configured to update stored keywords according to search queries submitted to said search-engine server and documents responsive thereto.

46. The system of claim 39, further comprising a search-engine module operative for allowing users to use at least one user application for searching said network accessible associative memory according to an indicia.
